(19) United States
(12) Patent Application Publication
(10) Pub. No.: US 2008/0059377 A1
(43) Pub. Date: Mar. 6, 2008

(54) METHOD FOR MANAGING COPY PROTECTION INFORMATION OF RECORDING MEDIUM

(75) Inventors: Byung Jin KIM, Kyunggi-do (KR); Hyung Sun KIM, Seoul (KR)

Correspondence Address: BIRCH STEWART KOLASCH & BIRCH, PO BOX 747, FALLS CHURCH, VA, 22040-0747, US

(73) Assignee: LG ELECTRONICS INC.

(21) Appl. No.: 11/930,598

(22) Filed: Oct. 31, 2007

Related U.S. Application Data
(63) Continuation of application No. 10/831,170, filed on Apr. 26, 2004.

(30) Foreign Application Priority Data
Apr. 24, 2003 (KR) 10-2003-0026149

(51) Int. Cl. H04L 9/00

(52) U.S. Cl. 705/51

(57) ABSTRACT

A method for managing copy protection information of a recording medium is disclosed. Copy protection information for decrypting A/V data encrypted and recorded in a data area of an optical disc is recorded in a key locker of the disc. Information of makers that have manufactured optical disc drives, drive maker keys of each maker and flags indicating whether drive keys are valid or not is included in association with each other in the key locker. To reproduce the A/V data, the copy protection information is read and decrypted by comparing a drive key managed in the optical disc drive with the key renewal information recorded in the optical disc. Accordingly, illegally duplicated optical disc drives can no longer perform a normal playback operation, thereby effectively suppressing illegal duplication of optical disc drives, which also prevents optical disc drives of all makers from being duplicated at once.

### CROSS-REFERENCE TO RELATED APPLICATION

The present application is a 37 C.F.R. §1.53(b) continuation of U.S. application Ser. No. 10/831,170 filed Apr. 26, 2004, which claims priority on Korean Patent Application No. 03-26149 filed Apr. 24, 2003. The entire contents of each of these applications is hereby incorporated by reference.

### BACKGROUND OF THE INVENTION

1. Field of the Invention

The present invention relates to a method for managing copy protection information of a recording medium, and more particularly to a method for improving the security of copy protection information for decrypting A/V data encrypted and recorded in a data area of an optical disc such as a CD (Compact Disc), a DVD (Digital Versatile Disc) or a BD (Blue-ray Disc).

2. Description of the Related Art

Generally, an optical disc, for example a CD or a DVD, capable of recording digital video or audio data has been widely used and commercialized, and as the standardization of a high-density optical disc such as a BD has progressed rapidly, related products are expected to be commercialized in the near future.

To prevent illegal and unauthorized duplication of contents of digital video or audio data recorded in such an optical disc, a copy protection information management method has been proposed in which A/V data encrypted using copy protection information is recorded in a data area of an optical disc and the copy protection information is recorded and managed in a specific area, such as a lead-in area, of the optical disc. This method is described in detail as follows.

FIG. 1 is a block diagram showing the configuration of an optical disc drive 200 and an application 300 to which a general method for managing copy protection information of DVDs is applied. As shown in FIG. 1, the optical disc drive 200 may include an authentication block 20, a key sharing block 21, and encryption blocks 22 and 23.

The application 300 such as a personal computer (PC) may include an authentication block 30, a key sharing block 31, decryption blocks 32 and 33, a descrambler block 34, a decompression block 38, a description disc key 36, and a description title key 37.

An authentication control key, a secured disc key, an encrypted title key, and scrambled A/V data may be stored in a DVD 100 to be inserted into the optical disc drive 200.

The authentication block 20 of the optical disc drive 200 uses an authentication control key read from the DVD 100 to perform a series of authentication processes for transmission and reception of data to and from the authentication block 30 of the application 300. Using a predetermined encryption key provided from the key sharing block 21, the encryption blocks 22 and 23 re-encrypt a secured disc key and an encrypted title key read from the DVD 100 into data suitable for transmission and reception, and then transmit the re-encrypted data.

Using a predetermined description key provided from the key sharing block 31, the decryption blocks 32 and 33 of the application 300 perform a series of operations to decrypt a secured disc key and an encrypted title key received from the optical disc drive 200.

The disc key is decrypted using a master key 35 managed in the application 300, and the title key is decrypted using the decrypted disc key. The descrambler block 34 uses the title key to descramble scrambled A/V data read from the DVD 100. The decompression block 38 decompresses the descrambled A/V data to output original A/V data. Such processes make it possible to prevent unauthorized and illegal duplication of contents of audio or video data scrambled and recorded in the DVD 100.

However, the copy protection information such as the secured disc key and the encrypted title key recorded in the DVD may be illegally hacked and distributed by a third party such as a hacker, allowing illegal duplication of the A/V data encrypted and recorded in the data area of the DVD. It is thus urgently needed to provide an effective solution that can sufficiently reinforce the security of the copy protection information.

### SUMMARY OF THE INVENTION

Therefore, the present invention has been made in view of the above problems, and it is an object of the present invention to provide a method for managing copy protection information of a recording medium, which sufficiently reinforces the security of copy protection information.

It is another object of the present invention to provide a method for managing copy protection information of a recording medium, whereby an illegally duplicated optical disc drive can no longer perform a normal playback operation.

In accordance with the present invention, the above and other objects can be accomplished by the provision of a method for managing copy protection information of a recording medium, comprising: recording copy protection information in a first specific area of a recording medium, said copy protection information being used for decrypting data encrypted and recorded in a data area of the recording medium; recording a first key in a second specific area of the recording medium, said first key being used for decrypting the copy protection information; and recording key renewal information in the first specific area, said key renewal information indicating whether a second key required to decrypt the copy protection information is valid or not, wherein the second key is managed in a drive or an application for playing recording mediums.

In accordance with another aspect of the present invention, there is provided a recording medium comprising: a data area in which data encrypted using copy protection information is recorded; a first specific area in which the copy protection information and key renewal information are recorded, said key renewal information indicating whether a second key required to decrypt the copy protection information is valid or not; and a second specific area in which a first key for decrypting the copy protection information is recorded.

In accordance with yet another aspect of the present invention, there is provided a method for managing copy protection information of a recording medium, the method comprising the steps of: a) reading key renewal information in a first specific area of a recording medium using a first key and a second key, said first key being read from a second specific area of the recording medium, said second key being managed in a drive or an application for playing the recording medium; b) determining, based on the read key renewal information, whether the second key is valid or not; and c) decrypting copy protection information, recorded in the first specific area, using the first and second keys according to the determination at said step b).

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of an optical disc drive and an application to which a general method for managing copy protection information of a DVD is applied;

FIGS. 2 and 3 are block diagrams showing the configuration of an optical disc drive to which a method for managing copy protection information of a recording medium according to one embodiment of the present invention is applied;

FIGS. 4 and 5 are block diagrams showing the configuration of an optical disc drive and an application to which a method for managing copy protection information of a recording medium according to another embodiment of the present invention is applied; and

FIGS. 6 to 8 are diagrams illustrating an embodiment of key renewal information additionally recorded in a key locker of an optical disc according to the present invention.

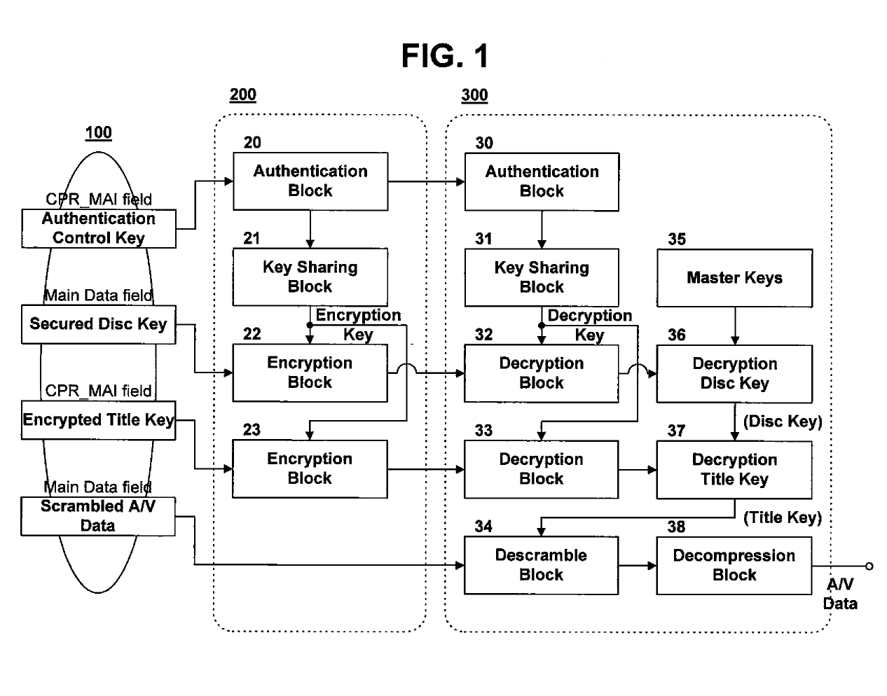

### DETAILED DESCRIPTION OF PREFERRED EMBODIMENTS

Preferred embodiments of a method for managing copy protection information of a recording medium according to the present invention will now be described in detail with reference to the accompanying drawings.

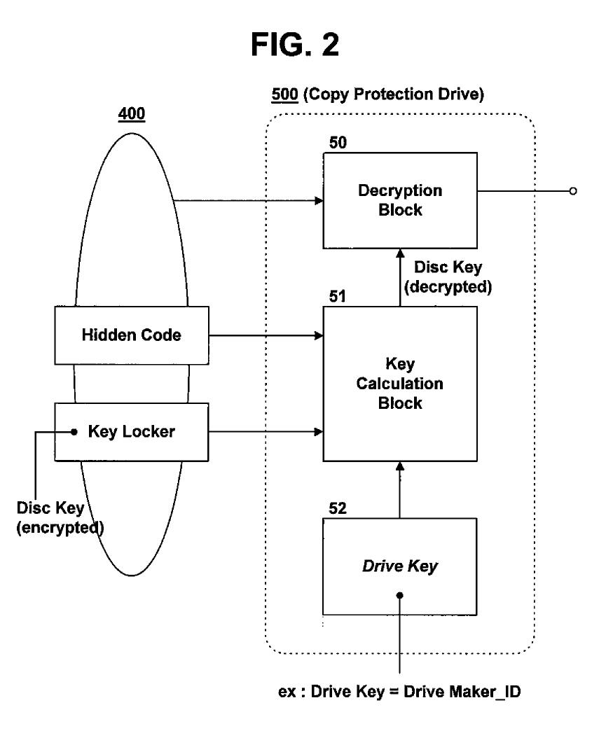

FIG. 2 is a block diagram showing the configuration of an optical disc drive 500 to which the method for managing the copy protection information of the recording medium according to the present invention is applied. As shown in this figure, the optical disc drive 500 may include a decryption block 50 and a key calculation block 51. A drive key 52 newly defined according to the present invention may be managed in the optical disc drive 500.

Copy protection information, for example an encrypted disc key, is recorded in a key locker provided in an optical disc 400 to be inserted into the optical disc drive 500. In addition, a hidden code having a first key value for reading the disc key is recorded in a pre-recorded form in a specific area of the optical disc 400, for example in a pre-recorded (embossed) area of a lead-in area of the optical disc 400.

The disc key recorded in the key locker is read and decrypted using a valid key value that is calculated by a combination of the hidden code having the first key value and the drive key having a second key value, which is managed in the optical disc drive 500. This improves the security of the copy protection information.

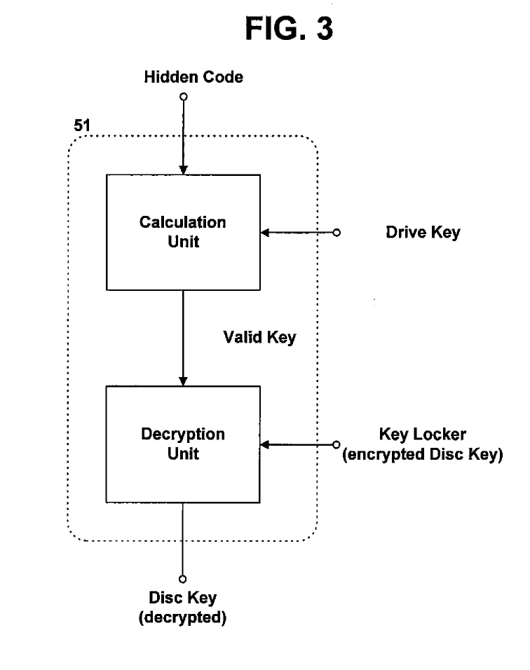

As shown in FIG. 3, the key calculation block 51 of the optical disc drive 500 may include a calculation unit (not referenced) for calculating a valid key that allows the key locker to be unlocked by a combination of the hidden code and the drive key, and a decryption unit (not referenced) for decrypting the disc key encrypted and recorded in the key locker using the calculated valid key.

The drive key can be managed with a different key value depending on optical disc drives. For example, the drive key can be managed with a unique key value identified by a drive ID (Drive_ID) of a maker that has manufactured the optical disc drive.

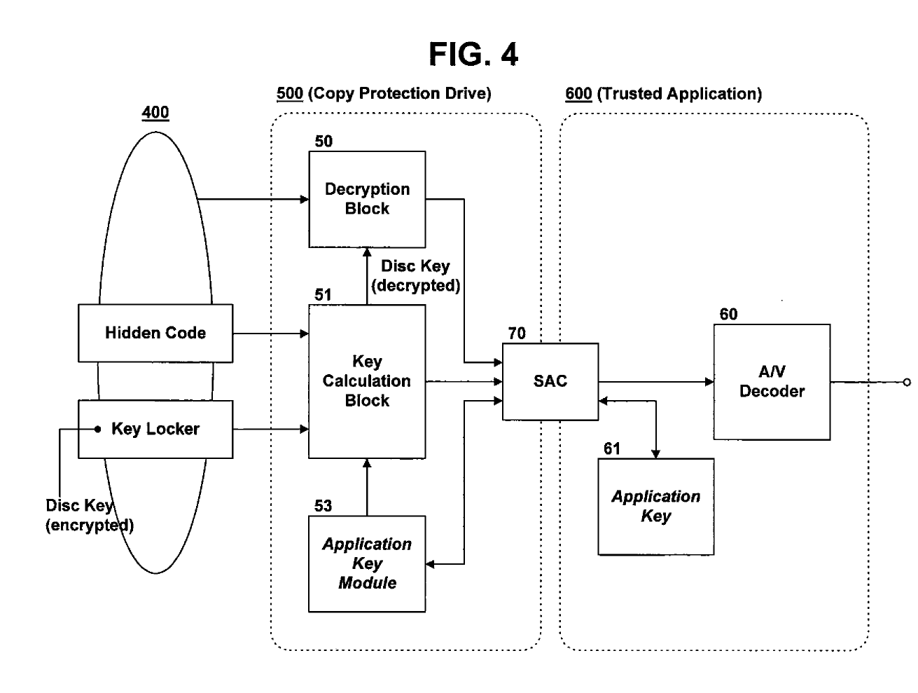

As shown in FIG. 4, the optical disc drive 500 can be used in connection with an application 600 (for example, a personal computer) to and from which the optical disc drive 500 transmits and receives data through a secure authenticated channel (SAC) 70. The application 600 includes an A/V decoder 60 for decoding A/V data received through the secure authenticated channel 70.

The application 600 may manage an application key 61 therein, and the optical disc drive 500 may include an application key module 53 therein. In this case, the application key module 53 receives the application key 61 managed in the application 600 through the secure authenticated channel 70, and then provides the received application key 61 to the key calculation block 51.

The key calculation block 51 in the optical disc drive 500 reads and decrypts the disc key in the key locker recorded in the optical disc by a combination of the hidden code having the first key value and the drive or application key having the second key value, which is managed in the optical disc drive 500 or in the application 600.

The decryption block 50 performs a series of operations for decrypting audio and video data, encrypted and recorded in the data area of the optical disc, using the disc key. The decryption block 50 then outputs the decrypted audio and video data to the application 600 through the secure authenticated channel 70.

The A/V decoder 60 included in the application 600 decodes the audio and video data, received from the optical disc drive 500 in such a manner, to recover audio and video signals. In such a manner, the audio and video data recorded in the optical disc is normally reproduced.

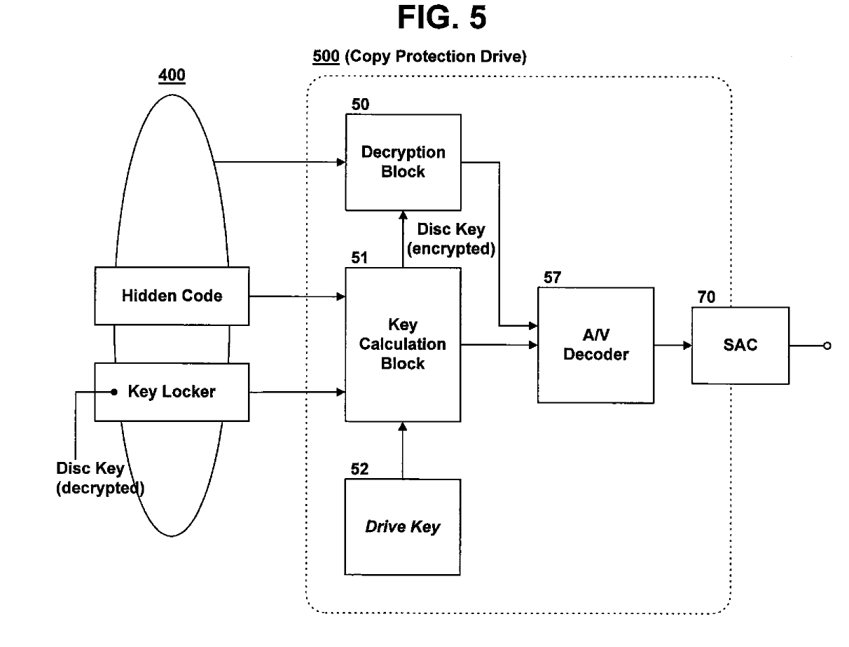

As shown in FIG. 5, an A/V decoder 57 may also be provided not in the application 600 but in the optical disc drive 500. In this case, since the optical disc drive 500 outputs completely decoded audio and video data to the application 600 through the secure authenticated channel 70, the optical disc drive 500 can reduce the risk of hacking of the copy protection information, compared to when bit streams of the audio and video data are transmitted directly to the application 600 as shown in FIG. 4.

In the case of FIG. 5, the optical disc drive 500 does not include the application key module 53 therein but manages a drive key 52 therein as shown in FIG. 5.

For reference, the hidden code is recorded on the optical disc in the form of wobble pre-pits (as a wobble pre-pit type) or in the form of a physical wobble having a low frequency component, so that it cannot be illegally duplicated using a bit to bit copy. The drive key, the disc key included in the key locker, or the like can also be recorded in the lead-in area of the optical disc in the form of wobble pre-pits (as a wobble pre-pit type) or in the form of a physical wobble having a low frequency component, as with the hidden code. Various additional information, in addition to the copy protection information such as the disk key, may be encrypted and recorded in the key locker, which is encrypted by the hidden code and the drive key.

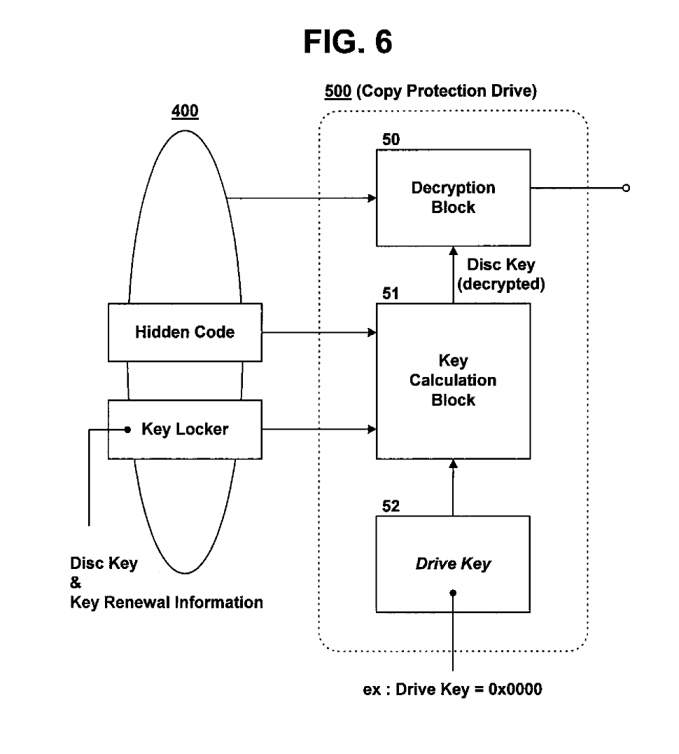

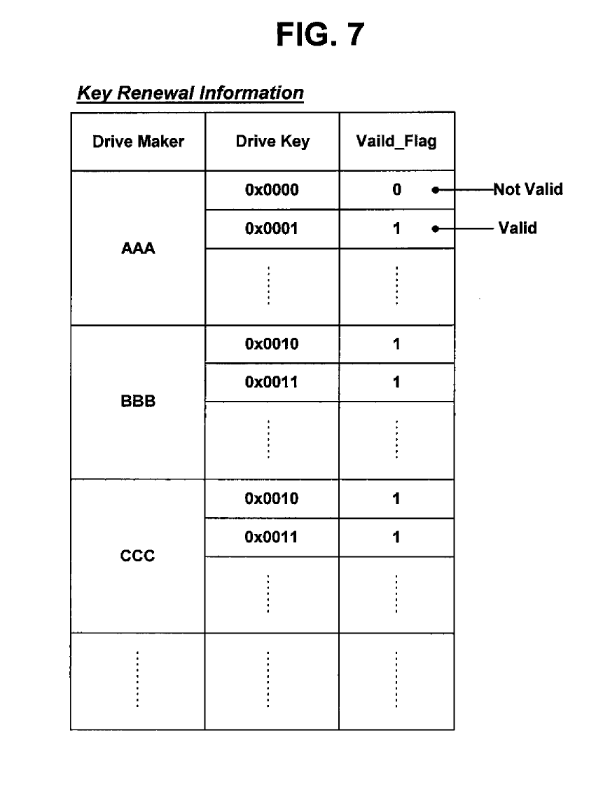

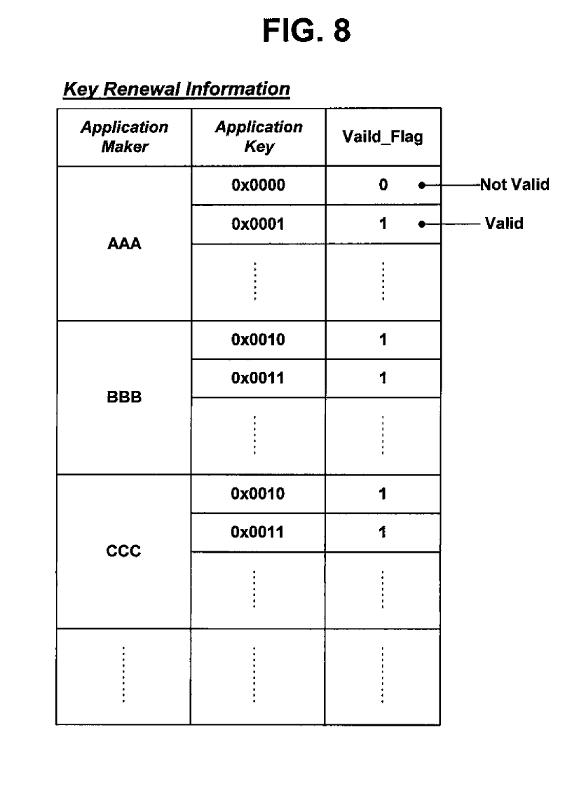

For example, key renewal information, in addition to the copy protection information, may be encrypted and recorded in the key locker of the optical disc 400, as shown in FIG. 6. As shown in FIG. 7, the key renewal information includes information of optical disc drive makers (Drive Maker), drive keys of each maker (Drive Key), and valid flags (Valid_Flag) indicating whether the drive keys are valid or not, which are recorded in association with each other. As shown in FIG. 8, the key renewal information may also include information of application makers (Application Maker), application keys of each maker (Application Key) and valid flags (Valid_Flag) indicating whether the application keys are valid or not, which are recorded in association with each other.

If an optical disc drive 500 or an application 600, which has been manufactured by a specific maker, has been illegally duplicated without permission, particularly if a drive manufacturer, who must comply with the copy protection system, has manufactured an optical disc drive without license contract with a licensor, new key renewal information is recorded in new optical discs that are manufactured thereafter, so that a drive or application key corresponding to the optical disc drive or application, which has been illegally duplicated or manufactured with no license, is not valid any longer.

For example, let us assume that an optical disc drive manufactured by a maker ‘AAA’ was illegally duplicated while a drive key ‘0x0000’ was recorded in the optical disc drive. Then, a content provider that produces optical discs resets a valid flag, corresponding to the drive key ‘0x0000’ of the maker ‘AAA’, in key renewal information to be recorded in newly produced optical discs, so that the valid flag has a bit value of ‘0’ to indicate that the drive key ‘0x0000’ of the maker ‘AAA’ is not valid, as shown in FIG. 7. The content provider records the key renewal information, which includes the reset valid flag recorded in association with information of the maker ‘AAA’ and the drive key ‘0x0000’, in the newly produced optical discs.

The content producers then allows information of a drive key (for example, ‘0x0001’), which is managed in newly produced optical disc drives, and information of a corresponding valid flag, whose bit is set to ‘1’ to indicate that the drive key ‘0x0001’ is valid, to be included in the key renewal information in association with the information of the maker ‘AAA’.

A key calculation block 51 of a newly produced optical disc drive reads key renewal information in a key locker of an optical disc 400 by a combination of a drive or application key managed in the optical disc drive or application and a hidden code read from the optical disc 400.

Copy protection information recorded in the key locker is read and decrypted with reference to the information of makers, drive or application keys of each maker, and valid flags indicating whether the drive or application keys are valid or not, which is included in the read key renewal information.

If the drive or application key managed in the optical disc drive or application is ‘0x0001’, a corresponding flag bit included in the read key renewal information is ‘1’, and it is thus determined that the drive or application key managed in the optical disc drive or application is valid. Accordingly, the copy protection information is normally read and decrypted, allowing audio and video data encrypted and recorded in the data area of the optical disc to be normally reproduced.

On the other hand, if the drive or application key managed in the optical disc drive or application is ‘0x0000’, a corresponding flag bit included in the read key renewal information is ‘0’, and it is thus determined that the drive or application key managed in the optical disc drive or application is invalid. Accordingly, the copy protection information is not permitted to be normally read and decrypted, preventing audio and video data encrypted and recorded in the data area of the optical disc from being normally reproduced.

In this case, the copy protection information is also decrypted by a combination of the hidden code and the drive or application key. However, the copy protection information may be obtained without being decrypted if it is determined, based on the flag bit included in the key renewal information, that the drive or application key managed in the optical disc drive or application is valid.

As apparent from the above description, the present invention can significantly improve the security of copy protection information.

In addition, the present invention effectively suppresses illegal duplication of an optical disc drive.

Further, the present invention disables illegally duplicated optical disc drives, and particularly prevents drives produced without license from playing optical discs.

Furthermore, the present invention can prevent optical disc drives of all makers from being duplicated at once.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for managing copy protection information, the method comprising:
reading copy protection information used for decrypting encrypted data, the copy protection information to be decrypted using a combination key which is a combination of a first and a second key;
decrypting the copy protection information using the combination key;
and decrypting the encrypted data using the copy protection information,
wherein the first key is a private code and the second key is managed in a device and based on a key renewal information renewedly generated by a server according to changes in validity of the device.

2. A device for managing copy protection information, the device comprising:
a calculation block adapted to read copy protection information used for decrypting encrypted data and further to calculate a combination key by a combination of a first and a second key, thereby decrypting the copy protection information using the combination key; and
a decryption block adapted to decrypt the encrypted data using the copy protection information,
wherein the first key is a private code and the second key is managed in the device and based on a key renewal information renewedly generated by a server according to changes in validity of the device.

3. A computer readable recording medium recording software to perform a method for managing copy protection information, the method comprising:
reading copy protection information used for decrypting encrypted data, the copy protection information to be decrypted using a combination key which is a combination of a first and a second key;
decrypting the copy protection information using the combination key;
and decrypting the encrypted data using the copy protection information,
wherein the first key is a private code and the second key is managed in a device and based on a key renewal information renewedly generated by a server according to changes in validity of the device.
